(19) United States
(12) Patent Application Publication
(10) Pub. No.: US 2018/0188828 A1
(43) Pub. Date: Jul. 5, 2018

(54) MULTIFUNCTIONAL WEARABLE DEVICE

(71) Applicant: Lantz Biles, Feasterville, PA (US)

(72) Inventor: Lantz Biles, Feasterville, PA (US)

(21) Appl. No.: 15/397,727

(22) Filed: Jan. 4, 2017

(51) Int. Cl. G06F 3/0346; G06F 1/16

(52) U.S. Cl. CPC G06F 3/0346; G06F 1/163

(57) ABSTRACT

A multifunctional wearable device for a user is disclosed. The multifunctional wearable device comprises a display unit removably attached to a casing structure, wherein the display unit is configured to receive a user-defined input on a user-interface. A control unit is configured to process the user-defined input based on the predefined data stored on a memory unit and a battery unit is configured to provide power for the wearable device. The display unit is configured to act as a remote monitor for an input device, wherein the data from the input device is projected onto the remote monitor via a wireless communication.

### BACKGROUND

Globally, the use of computers is widespread and people require continuous access to their computing devices for their personal and professional commitments. In the recent times, the use of portable and handy computing devices such as tablet, PDA and smartphones have become increasingly popular. However, these devices are easily misplaced and lost due to their compact nature.

Prior art attempts have been made to provide many wearable computing devices wherein the person may wear them as an accessory or a smartwatch. These devices have all computing features inbuilt but the design is cumbersome and does not allow the person to maximize the capabilities. In other words, the features are limited and not enough to carry out all the required tasks.

Prior art reference U.S. Pat. No. 6,970,157 discloses a wrist worn computing device wherein computing mechanism is attached to the band and operably coupled to the input and display mechanism. However, the display is fixedly attached to the wrist worn computing device and a support hinge is required to connect the wrist worn computing device to any external device.

In light of the aforementioned drawbacks and limitations, there exists a need for a wearable device for a user to connect any input device wirelessly.

### SUMMARY

The objective of the present invention is to provide a multifunctional wearable device for a user. The multifunctional wearable device comprises a display unit removably attached to a casing structure, wherein the display unit is configured to receive a user-defined input on a user-interface. A control unit is configured to process the user-defined input based on the predefined data stored on a memory unit and a battery unit is configured to provide power for the wearable device. The display unit is configured to act as a remote monitor for an input device, wherein the data from the input device is projected onto the remote monitor via a wireless communication.

According to one embodiment of the present invention, the input device is selected from at least one of a keyboard, a mouse, a joystick, a track ball, a light pen, a digitizer and a touchscreen. The remote monitor is connected to the input device via at least one of a wireless communication, a Bluetooth communication, Wi-Fi, WiDi and a Near Field Communication.

According to another embodiment of the present invention, the display unit is rotatably attached to the casing structure to configure the display orientation wherein a hinge mechanism is configured to rotate the display unit that is removably attached to the casing structure.

### BRIEF DESCRIPTIONS OF SEVERAL VIEWS OF DRAWINGS

FIG. 1A illustrates a multifunctional wearable device worn by a user, incorporating the aspects of the present invention.

FIG. 1B illustrates a display unit of the multifunctional wearable device in display orientation, incorporating the aspects of the present invention.

FIG. 2 illustrates the display unit of multifunctional wearable device connected to an input device, incorporating the aspects of the present invention.

### DETAILED DESCRIPTION OF DIFFERENT EMBODIMENTS

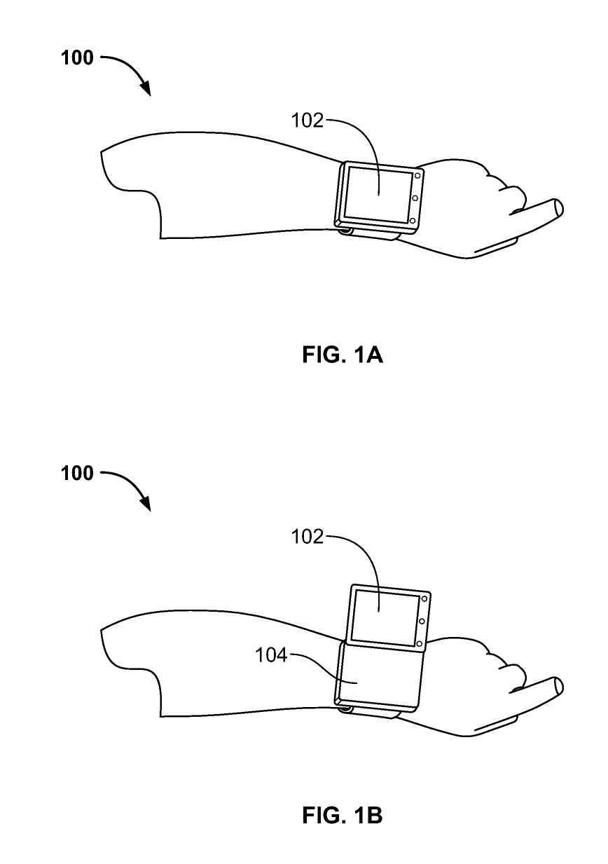

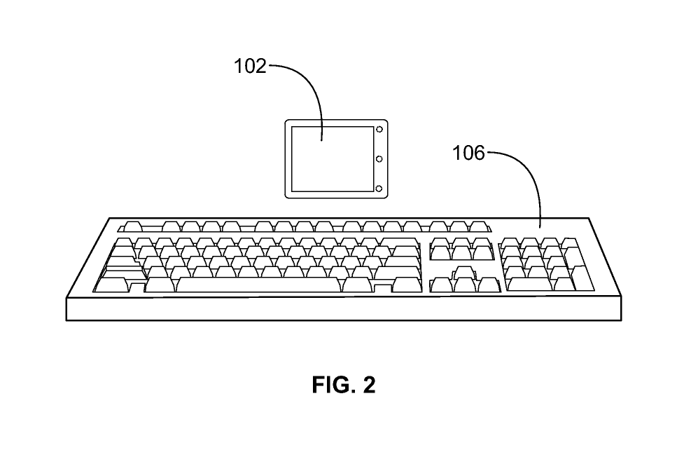

The present invention is related to a multifunctional wearable device 100 for a user as shown in FIG. 1A. The multifunctional wearable device 100 comprises a display unit 102 removably attached to a casing structure 104, wherein the display unit 102 is configured to receive a user-defined input on a user-interface as shown in FIG. 1B. A control unit is configured to process the user-defined input based on the predefined data stored on a memory unit and a battery unit is configured to provide power for the wearable device 100. The display unit 102 is configured to act as a remote monitor for an input device 106, wherein the data from the input device 106 is projected onto the remote monitor via a wireless communication as shown in FIG. 2. The display unit 102 could be separated from the casing structure 104 and could be used with any input device 106 in the wireless communication mode. The display unit 102 is wirelessly connected to a monitor configured to project the screen.

In an embodiment as shown in FIG. 1B, the display unit 102 of the multifunctional wearable device 100 is rotatably attached to the casing structure 104 to configure the display orientation wherein a hinge mechanism is configured to rotate the display unit 102 that is removably attached to the casing structure 104. This allows the user to make use of the display unit 102 when it is attached to the casing structure 104. The input device 106 is selected from at least one of a keyboard, a mouse, a joystick, a track ball, a light pen, a digitizer and a touchscreen. The remote monitor is connected to the input device via at least one of a wireless communication, a Bluetooth communication, Wi-Fi, WiDi and a Near Field Communication.

In an embodiment as shown in FIG. 1B, the multifunctional wearable device 100 is used as a wristband wherein the casing structure 104 is supported by a hollow sleeve at both the ends to wrap the wearable device 100 around the wrist of the user. The user-interface of the display unit 102 is configured to have control buttons to manually configure the wearable device 100. The casing structure 104 and the hollow sleeves are made from a resilient material to adjustably wrap the wearable device 100 around the wrist of the user. The user-interface of the display unit 102 is in communication with the processor to process the user-defined input based on the predefined data stored on a memory unit and so the user can operate the display unit 102 by rotating them in different display orientation modes.

In a different embodiment as shown in FIG. 1A, the user interface of the display unit 102 is configured to display touch-sensitive icons and data selected from at least one of a day, date, time, or icons indicating the number of email messages, notifications or appointment alerts.

In another embodiment as shown in FIG. 2, whenever the user needs to connect the display unit 102 with any input device 106, the user could simply rotate the display unit 102 with respect to the casing structure 104 and remove the display unit 102 and place them with the input device 106 to be connected. In preferred embodiments, the input device 106 is a keyboard. The wireless communication is enabled between the display unit 102 and the input device 106 and thereafter, the user could provide inputs via the input device 106 to execute their tasks displayed in the display unit 102. In additional embodiments, the screen from the display unit 102 could be projected onto any external monitor or other display devices.

The multifunctional wearable device 100, according to the present invention is configured to allow the user to remove the display unit 102 from the casing structure 104 of the device 100 and connect with any external input device 106 conveniently using the wireless connection. The display unit 102 is easily detachable from the device 100 and without any external connector, the display unit 102 could connect the input device 106 wirelessly. The user need not to remove the wristband from the hand and just detaching the display unit 102 from the casing structure 104 and connect it to the input device 106 with convenient focus and range. The display unit screen and keyboard could be projected from the display unit 102 or linked to any monitor through WiFi.

Although the present invention has been described herein in the context of a particular implementation in a particular environment for a particular purpose, those of ordinary skill in the art will recognize that its usefulness is not limited thereto and that the present invention may be beneficially implemented in any number of environments for any number of purposes. Accordingly, the claims set forth below should be construed in view of the full breadth and spirit of the present invention as described herein.

I claim:

1. A multifunctional wearable device comprising:
a display unit removably attached to a casing structure, wherein the display unit is configured to receive a user-defined input on a user-interface;
a control unit is configured to process the user-defined input based on the predefined data stored on a memory unit;
a battery unit is configured to provide power for the wearable device;
wherein the display unit is configured to act as a remote monitor for an input device, wherein the data from the input device is projected onto the remote monitor via a wireless communication.

2. The multifunctional wearable device of claim 1, wherein the input device is selected from at least one of a keyboard, a mouse, a joystick, a track ball, a light pen, a digitizer and a touchscreen.

3. The multifunctional wearable device of claim 1, wherein the display unit is rotatably attached to the casing structure to configure the display orientation.

4. The multifunctional wearable device of claim 3, wherein a hinge mechanism is configured to rotate the display unit removably attached to the casing structure for display orientation.

5. The multifunctional wearable device of claim 1, wherein the display unit is wirelessly connected to a monitor configured to project the screen.

6. The multifunctional wearable device of claim 1, wherein the remote monitor is connected to the input device via at least one of a wireless communication, a Bluetooth communication, Wi-Fi, WiDi and a Near Field Communication.

7. The multifunctional wearable device of claim 1, wherein the casing structure is supported by a hollow sleeve at both the ends to wrap the wearable device around the wrist of the user.

8. The multifunctional wearable device of claim 1, wherein the user-interface of the display unit is implemented with one or more control buttons to manually operate the wearable device.

9. The multifunctional wearable device of claim 1, wherein the casing structure and the hollow sleeves are made from a resilient material to adjustably wrap the wearable device around the wrist of the user.

10. The multifunctional wearable device of claim 1, wherein the user-interface of the display unit is in communication with the processor to process the user-defined input based on the predefined data stored on a memory unit.
